(19) United States
(12) Patent Application Publication
(10) Pub. No.: US 2003/0009347 A1
(43) Pub. Date: Jan. 9, 2003

(54) Method and system for surveillance and operation services of power generating equipment

(76) Inventors: Yasushi Iwai, Hitachi (JP); Shigeaki Namba, Hitachi (JP); Kunio Asai, Hitachi (JP); Katsuyuki Yamasaki, Kashiwa (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/100,083

(22) Filed: Mar. 19, 2002

(30) Foreign Application Priority Data
Jul. 9, 2001 (JP) 2001-208196

(51) Int. Cl. G06F 17/60

(52) U.S. Cl. 705/1; 705/412

(57) ABSTRACT

Minimization of risks to be incurred by a generating plant firm at the time of the firm's non-fulfillment of an agreement for electric power supply which is attributed to an unscheduled shutdown of power generating equipment that supplies electric power to electric power systems. A service center takes an intermediary action for the conclusion of indemnity insurance agreements, in a lump, between a generating plant firm which has power generating equipment and an insurance company, and contracts another indemnity insurance agreement with an electric power company so that a penalty to be incurred at the time of a non-fulfillment of an agreement for electric power supply can be indemnified by the insurance company. Furthermore, the service center subcontracts a maintenance and management service of the power generating equipment, and offers information of operation information and the maintenance status of the power generating equipment to the insurance company for the calculation of insurance premiums.

### BACKGROUND OF THE INVENTION

The present invention relates to a method and a system for the surveillance and operation services of power generating equipment, and in particular to a method and a system for the surveillance and operation services of power generating equipment which is suitable for the power generating equipment that is installed for the purpose of selling electric power, a self-generation facility intending for selling surplus electric power, etc.

The deregulation of electric power supply is being increasingly accelerated in recent years, which in turn has been bringing up business opportunities, wherein business firms which have power generating equipment installed for selling electric power, or other business firms which have self-generation equipment wholesale or retail electric power through electric power systems, as generating plant firms.

In this type of business, consideration has been given to only preventing the unscheduled stoppage of power supply or a reduction in output by managing the power generating equipment itself; however, risk dodge means has not been taken adequately in terms of economic aspects under emergencies such as the unscheduled stoppage of power supply.

As the prior art relating to the management technology of power generating equipment, a technology described on Japanese Patent Application No. 2000-192651, for example, is known.

As described above, supplying electric power by a generating plant firm which has self-generation facilities implies that, if an unscheduled shutdown occurs in power generating equipment which supplies electric power to an electric power system, or if contracted output becomes unable to be supplied due to reduced output and so forth, the generating plant firm must pay a penalty to an operator of such electric power systems for compensation.

An object of the present invention is to provide a method and a system for surveillance and operation services of power generating equipment which enables to minimize risks of a generating plant firm to be incurred in a case where the generating plant firm fails to perform an agreement to supply electric power under emergencies such as an unscheduled shutdown of the power generating equipment.

### SUMMARY OF THE INVENTION

According to the present invention, the object stated above may be achieved, in a method for surveillance and operation services of power generating equipment that supplies electric power to an electric power system, comprising the steps of: taking an intermediary action to conclude a first steps of: taking an intermediary action to conclude a first indemnity insurance agreement between a generating plant firm which has power generating equipment and an insurance company for the soundness or the performance of said power generating equipment; concluding a second indemnity insurance agreement between a managing operator of said electric power system and an insurance company for the supply of electric power; and supplying a required amount of power when said electric power system is subjected to an unscheduled shutdown.

Likewise, the object stated above may be achieved, in a system for surveillance and operation services of power generating equipment that supplies electric power to an electric power system, comprising: power generating equipment which is owned by one or a plurality of generating plant firms which supply electric power to said electric power system; and a service center which carries out a surveillance service or an operation service of said power generating equipment to always to monitor the soundness of target power generating equipment, takes a first intermediary action to conclude an indemnity insurance agreement for the soundness or the performance of said power generating equipment between a generating plant firm which has the power generating equipment and an insurance company, and concludes a second indemnity insurance agreement for the supply of electric power between a managing operator of said electric power system and the insurance company so that a required amount of power may be supplied when said electric power system is subjected to an unscheduled shutdown.

### BRIEF DESCRIPTION OF THE DRAWINGS

The above and other objects, features and advantages of the present invention will become more apparent from the following description taken in connection with the accompanying drawings, in which:

FIG. 1 is a schematic diagram showing a surveillance and operation system configuration of power generating equipment according to a first embodiment of the present invention;

FIG. 2 is a diagram illustrating processing procedures in the system shown in FIG. 1;

FIG. 3 is a schematic diagram showing a configuration of a surveillance and operation system of power generating equipment according to a second embodiment of the present invention;

FIG. 4 is a schematic diagram showing a configuration of a surveillance and operation system of power generating equipment according to a third embodiment of the present invention; and

FIG. 5 is a configuration diagram showing an example of a hardware configuration according to an embodiment of the present invention.

### DETAILED DESCRIPTION OF THE PREFERRED EMBODIMENTS

Preferred embodiments of a method and a system for surveillance and operation services of power generating equipment according to the present invention will now be described in detail with reference to the accompanying drawings.

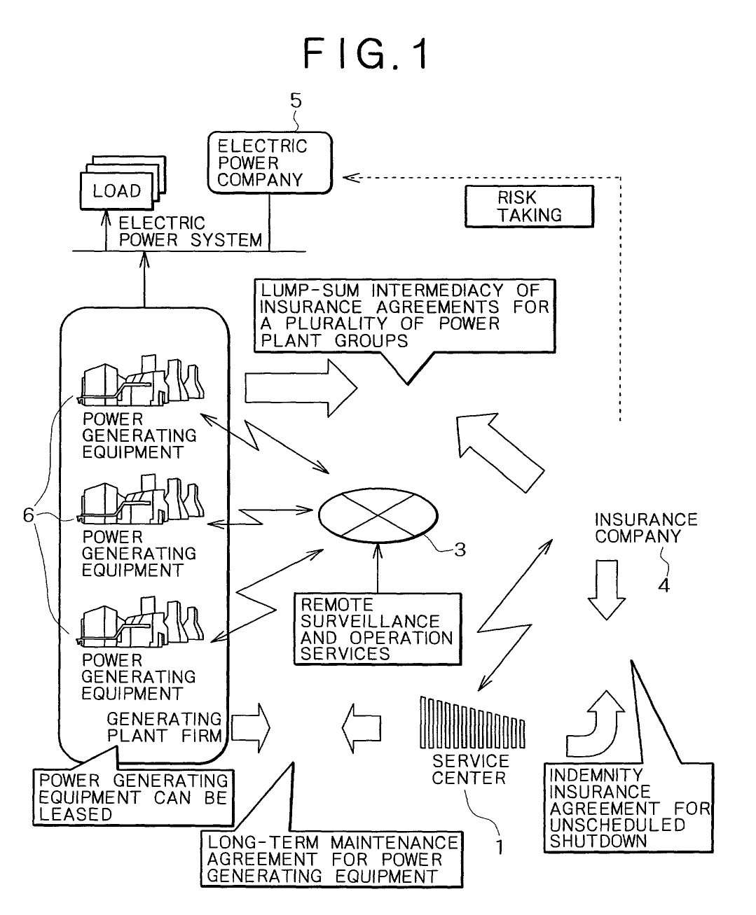

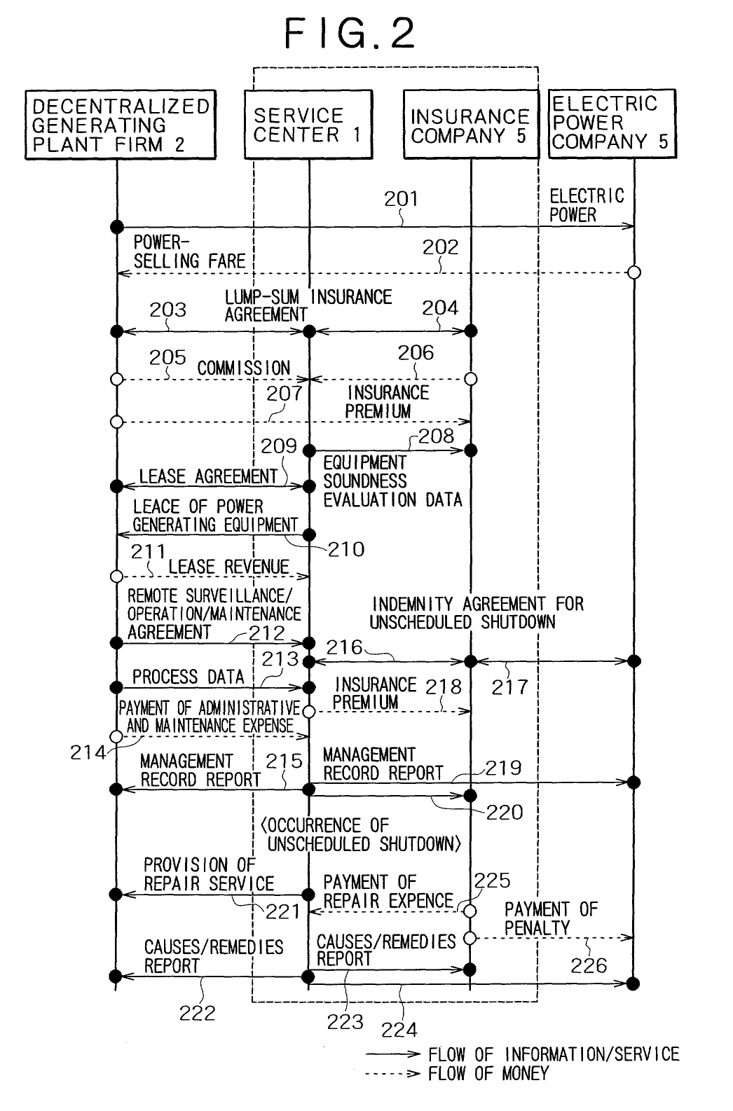

FIG. 1 is a schematic diagram illustrating a configuration of a method and a system for surveillance and operation services of power generating equipment according to the present invention. FIG. 2 is a diagram illustrating processing procedures in FIG. 1. In FIG. 1, reference numeral 1 stands for a service center; 2 denotes a generating plant firm; 3 represents a network; 4 indicates an insurance company; 5 shows an electric power company; and 6 stands for power generating equipment.

A system according to a first embodiment of the present invention shown in FIG. 1 comprises a service center 1 which executes maintenance services such as the surveillance and operation of power generating equipment 6; a generating plant firm 2 which performs a business to supply power to an electric power system; power generating equipment 6 which is owned by the generating plant firm 2; a managing operator of electric power system of an electric power company 5, etc. which purchases power; an insurance company 4 which underwrites an indemnity insurance for power supply; and a network 3 for such as a public telephone service and the Internet.

An embodiment of the present invention in FIG. 1 illustrates the case of only one business firm wherein the generating plant firm 2 has three units of power generating equipment 6. However, the generating plant firm 2 may be two or more firms each that have one or more pieces of power generating equipment. The service center 1 concludes a long-term maintenance agreement with the generating plant firm 2 for one or more pieces of power generating equipment owned by the generating plant firm 2, and accepts fees by offering maintenance services to the generating plant firm. The service center 1 offers remote surveillance and operation services for the power generating equipment owned by the generating plant firm 2, executes surveillance and operation services through the network 3 of an exclusive line, the Internet, and so forth, stores and retains operation information obtained through the services so that the generating plant firm 2 may access the operation information, etc., and further, periodically reports the management records of operations to the generating plant firm 2.

Furthermore, the service center 1 takes an intermediary action to conclude an insurance agreement for power generating equipment between the insurance company 4 and the generating plant firm 2, and avoids its own risk by concluding an indemnity insurance agreement to indemnify a penalty, to be paid to a managing operator of electric power sources of an electric power company, etc., which may be incurred at the time of the breach of agreement for supplying power attributed to emergencies such as an unscheduled shutdown. Also, the service center 1 periodically reports the operation status, etc. of the power generating equipment 6 as in the case of the generating plant firm 2, and discloses the necessary amount of information so that the insurance company 4 may access surveillance and operation information on a plant, via the network 3, such as of an exclusive line or the Internet to judge the soundness of the equipment. In such a manner, the insurance company 4 may confirm, as required, information regarding the operation status or the like of the power generating equipment 6 reported to the insurance company 4 by the service center 1.

In the above, the explanation is given under an assumption that the generating plant firm 2 has the power generating equipment 6. However, the present invention may also cover an embodiment wherein the service center 1 leases the power generating equipment 6 to the generating plant firm 2. In this case, the service center 1 leases the power generating equipment 6 to the generating plant firm 2 for the operation, and receives the reimbursement of the rental revenue out of their earnings obtained by selling power. It should be noted that the leasing of equipment to the generating plant firm 2 is not always be made to the entire power generating equipment, but may be made to part of the equipment. Leasing of the power generating equipment enables the generating plant firm 2 to introduce latest technologies available at a power generating equipment supplier and keep them updated. In addition, concluding a long-term maintenance agreement, between the generating plant firm 2 and the service center 1 which is a supplier of power generating equipment, for power generating equipment which is under a leasing agreement, enables the generating plant firm 2 to avoid extra expenditures during the life cycle period of the power generating equipment by paying a specific amount of money to the power generating equipment supplier in full at a time or by installments.

Upon the occurrence of emergencies of such as an unscheduled shutdown of the power generating equipment 6 owned by the generating plant firm 2, the service center 1 offers repair services pursuant to a maintenance agreement with the generating plant firm 2, receives a payment for the repair fee under the indemnity insurance agreement for the power generating equipment 6, and reports reasons and countermeasures to both the decentralized generating plant firm 2 and the insurance company 4.

For the sending and the receiving of information through the network 3, any interruptions made through the network 3 by third parties may be prevented by featuring a security function in communication means.

The insurance company 4 may set an insurance premium at a lower level, since they may calculate correct insurance premiums according to the frequency of breakdowns and defects or the like by referring to information received from the service center 1, indicating the operation status or the soundness of the equipment. In addition, upon the occurrence of an unscheduled shutdown of the power generating equipment, the insurance company 4 pays a penalty to a managing operator of an electric power system of the electric power company 5, etc. pursuant to an indemnity insurance agreement.

The managing operator of an electric power system of the electric power company 5. etc. is supplied with electric power to their electric power system by such an electric utility company as the generating plant firm 2, and pays the counter value, while receiving a report on the operation status, etc. of the power generating equipment 6 from the service center according to an indemnity insurance agreement concluded in advance with the insurance company 4 for unscheduled shutdowns, receiving the payment of penalty from the insurance company 4 should an unscheduled shutdown occurs in the power generating equipment 6, and receiving a report on the reasons and the countermeasures of such unscheduled shutdown from the service center 1.

In the first embodiment of the present invention stated above, the lease of power generating equipment is not always limited to the lease by the service center 1; however, it may be conducted by using another leasing company.

Next, a flow of information and a flow of various fees in the first embodiment of the present invention stated above will now be described with reference to FIG. 2.

(1) First, the generating plant firm 2 supplies power to electric power systems, and receives a power selling fare, as a counter value, from a managing operator of electric power system of the electric power company 5, etc. (Procedures 201 and 202).

(2) The service center 1 takes an intermediary action for insurance agreements in a lump to be contracted between one or more generating plant firms 2 which have power generating equipment and the insurance company 4, and receives commissions from both of the generating plant firm 2 and the insurance company 4 (Procedures 203 to 206).

(3) The generating plant firm 2 pays an insurance fee to the insurance company 4. At this time, as a material being used to appraise the insurance fee, the service center 1 provides the insurance company 4 with information which enables the insurance company to judge the soundness of the equipment. By using such information, the insurance company 4 may ask for the reduction in the amount of the insurance fee depending on cases (Procedures 207 and 208).

(4) In a case where the generating plant firm 2 leases the power generating equipment 6 from the service center 1, the firm concludes a lease agreement for the equipment. On the other hand, the service center 1 leases the power generating equipment 6 to the generating plant firm 2 so that the firm may construct and manage a power generating facility based on such leased equipment, and pay back the rental revenue out of their earnings obtained by selling power, etc. (Procedures 209 to 211).

(5) The generating plant firm 2 concludes a remote surveillance, operation and maintenance agreement for the power generating equipment 6 with the service center 1, pays administrative and maintenance expenses to the service center 1, transmits process information of the power generating equipment 6 to the service center 1 via the network 3, and receives a report on equipment management records regarding operation status, etc. of the power generating equipment 6 (Procedures 212 to 215).

(6) The service center 1 and a managing operator of electric power system of the electric power company 5, etc. concludes an indemnity insurance agreement for an unscheduled shutdowns with the insurance company 4, and the service center 1 pays an insurance fee to the insurance company 4, while offering a report on equipment management records regarding operation status, etc. of the power generating equipment 6 to both the insurance company 4 and a managing operator of electric power system of the electric power company 5, etc. (Procedures 216 to 220).

Although not illustrated in FIG. 2, another arrangement is also possible, wherein, in the preceding descriptions, the service center 1 establishes a situation that the insurance company 4 may access surveillance and operation information on the plant of the power generating equipment 6 in advance, and then discloses sufficient amount of information which enables the judgment of the soundness of the equipment so that the insurance company may independently confirm the soundness as required. By disclosing such information to the insurance company, the service center 1 may demonstrate the soundness of the power generating equipment 6, and expect the reduction in the premium fee in return.

(7) The generating plant firm 2 operates the power generating equipment 6 under the status described above. Thereafter, should an unscheduled shutdown of the power generating equipment 6 occur, the service center 1 provides the power generating equipment 6 owned by the generating plant firm 2 with repair services, and reports reasons and countermeasures to the generating plant firm 2. In addition, the report on reasons and countermeasures is also sent to the insurance company 4 and a managing operator of electric power system of the electric power company 5, etc. (Procedures 221 to 224)

(8) The insurance company 4 pays the repair fee to the service center 1 pursuant to an indemnity insurance agreement for an unscheduled shutdown, and also pays a penalty to a managing operator of electric power systems of the electric power company 5, etc. (Procedures 225 and 226).

According to the first embodiment of the present invention stated above, a risk to be incurred by a generating plant firm which sells such surplus power obtained from a self-generation facility that is generated during a non-performing period of a power supply agreement due to an unscheduled shutdown of power generating equipment, etc.

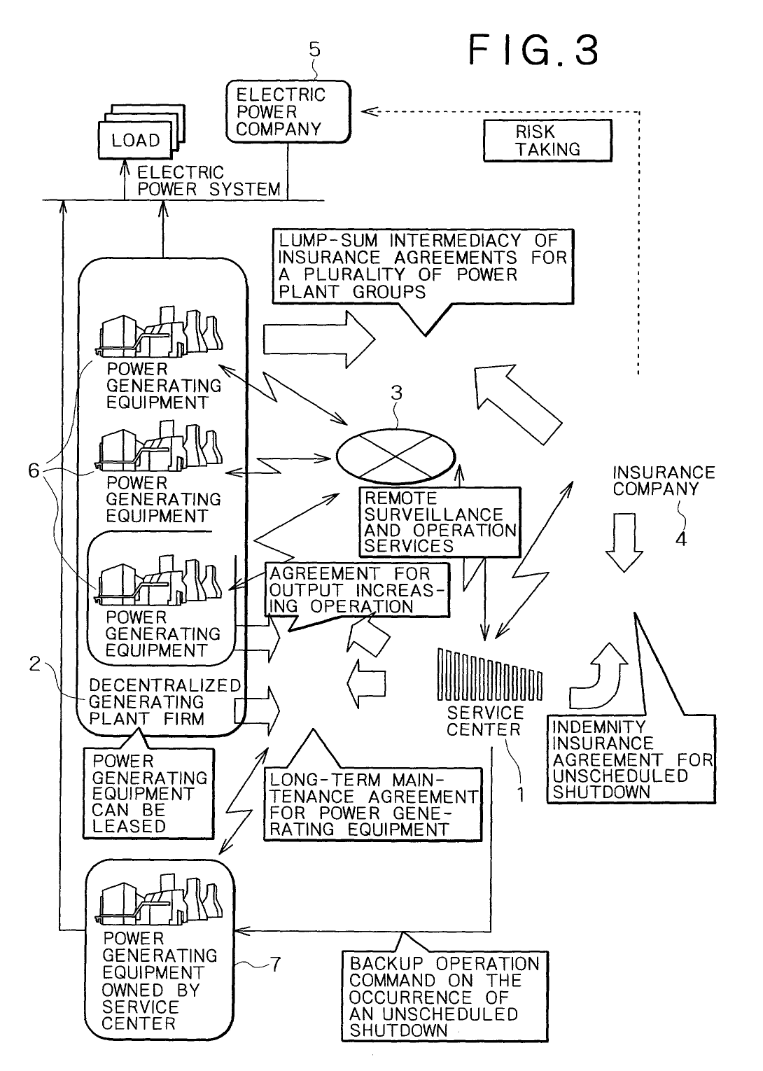

FIG. 3 illustrates a configuration of a surveillance and operation system of power generating equipment according to a second embodiment of the present invention. In FIG. 3, reference numeral 7 denotes power generating equipment owned by a service center, and other reference numerals indicate the same parts as those in FIG. 1.

In the second embodiment of the present invention shown in FIG. 3, power generating equipment 7 owned by the service center is added to the first embodiment shown in FIG. 1, whereby, should an unscheduled shutdown occur in either one of power generating equipment 6 which are under an agreement with the service center 1 and are installed at a generating plant firm 2, electric power will be secured and supplied by initiating the operation or increasing the output of the power generating equipment 7 owned by the service center 1, while using the power generating equipment 7 as a substitute power generating facility. With this arrangement, an insurance company 4 may reduce the amount of penalty payment to an electric power company 5, and the service center may consequently have a lower insurance fee.

In the preceding paragraph, a description is made by assuming a case where the service center 1 has the power generating equipment 7, and the equipment 7 is operated as a backup, should an unscheduled shutdown occur in one of the power generating equipment 6. However, the present invention is not limited to the arrangement. With the present invention, an another arrangement is possible, wherein an operation agreement for an increased output of the power generating equipment 6 is contracted in advance with one or more generating plant firms 2 which are under an agreement with the service center 1, so that, upon the occurrence of an unscheduled shutdown in power generating equipment, deficient power can be supplied by another power generating equipment 6 substituting the equipment in which the unscheduled shutdown has occurred. Of course, after concluding an operation agreement for the increased output, as stated above, with the generating plant firm 2, the service center 7 may additionally have the power generating equipment 7, and in this case, the service center 1 may reduce risks furthermore.

In the description stated above, if the service center 1 can predict such a situation as an unscheduled shutdown through the remote monitoring of the power generating equipment 6, the output of the power generating equipment 6, wherein the situation of an unscheduled shutdown is predicted, can be reduced upon the startup of substitution power generating equipment, thus enabling the service center 1 not to pay a penalty. Also, in such a case, the service center 1 can report the procedures to a managing operator of electric power systems in advance.

Should an event described in the above occur, the insurance company 4 pays a cost which is equivalent to the increased portion of fuel used and the consumed portion of the service life of the equipment to the generating plant firm 2 which owns the power generating equipment 6 that is subjected to an increased output operation as stated above. At this time, the service center 1 sends reports concerning reasons for the occurrence of a problem and the countermeasures to the generating plant firm 2 which owns the power generating equipment 6 that is subjected to an unscheduled shutdown as stated above and also to the insurance company 4.

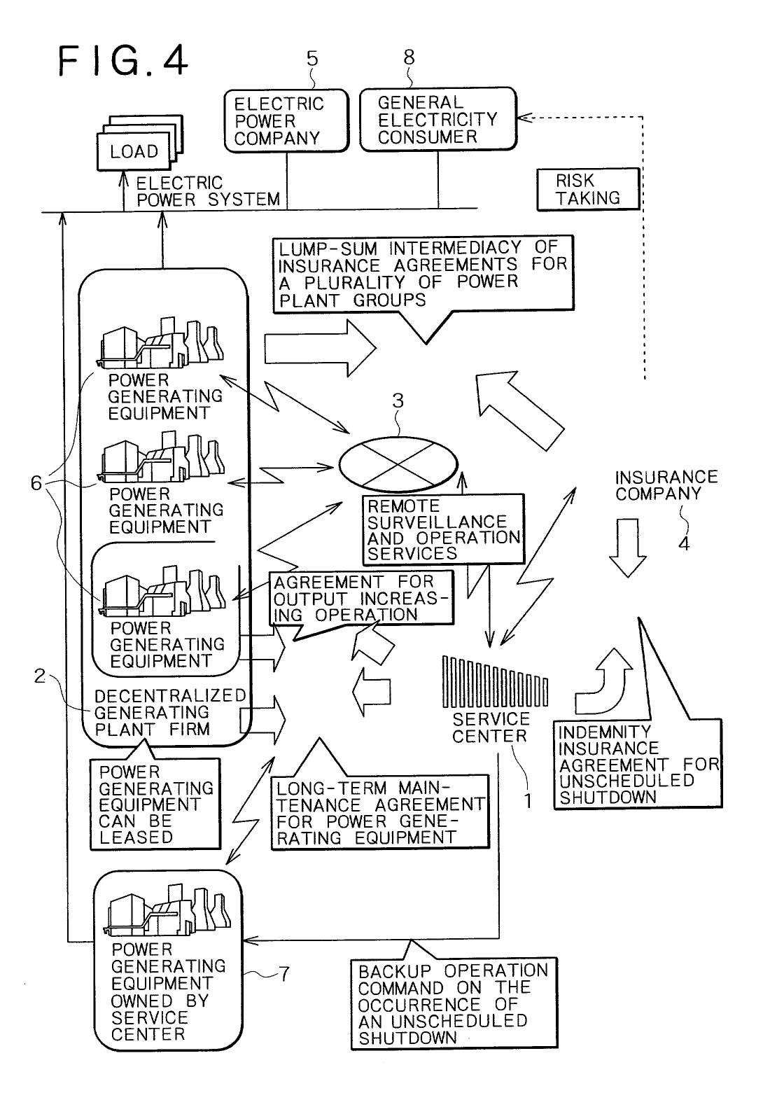

FIG. 4 is a schematic diagram illustrating a configuration of a surveillance and operation system of power generating equipment according to a third embodiment of the present invention. In FIG. 4, reference numeral 8 indicates a general electricity consumer and other reference numerals indicate the same parts as those in FIGS. 1 and 3.

In the third embodiment of the present invention shown in FIG. 4, a general electricity consumer 8 which receives the supply of electricity is added to the first and the second embodiments of the present invention described above, wherein the generating plant firm 2 is a managing operator of electric power systems of the electric power company 5., etc. which supplies electric power. In this case, the transaction may be directly made between the generating plant firm 2 and the general electric consumer 8, or otherwise, the service center 1 may conclude an agreement with a plurality of generating plant firms 2 in advance, and may supply power from a plurality of generating plant firms 2 to the general electric consumer 8.

In a case where the service center 1 concludes an agreement with a plurality of generating plant firms 2 in advance, and supplies power from a plurality of generating plant firms 2 to the general electric consumer 8, the service center 1 may renew an agreement for electric power charges by reviewing the electric power charges at regular periods or as necessitated. The renewal may be conducted, for example, by concluding an agreement for electric power charges on the basis of equipment whose unit cost of power is the highest among all pieces of power generating equipment 6 owned by the generating plant firm 2 which is under contract with the service center 1.

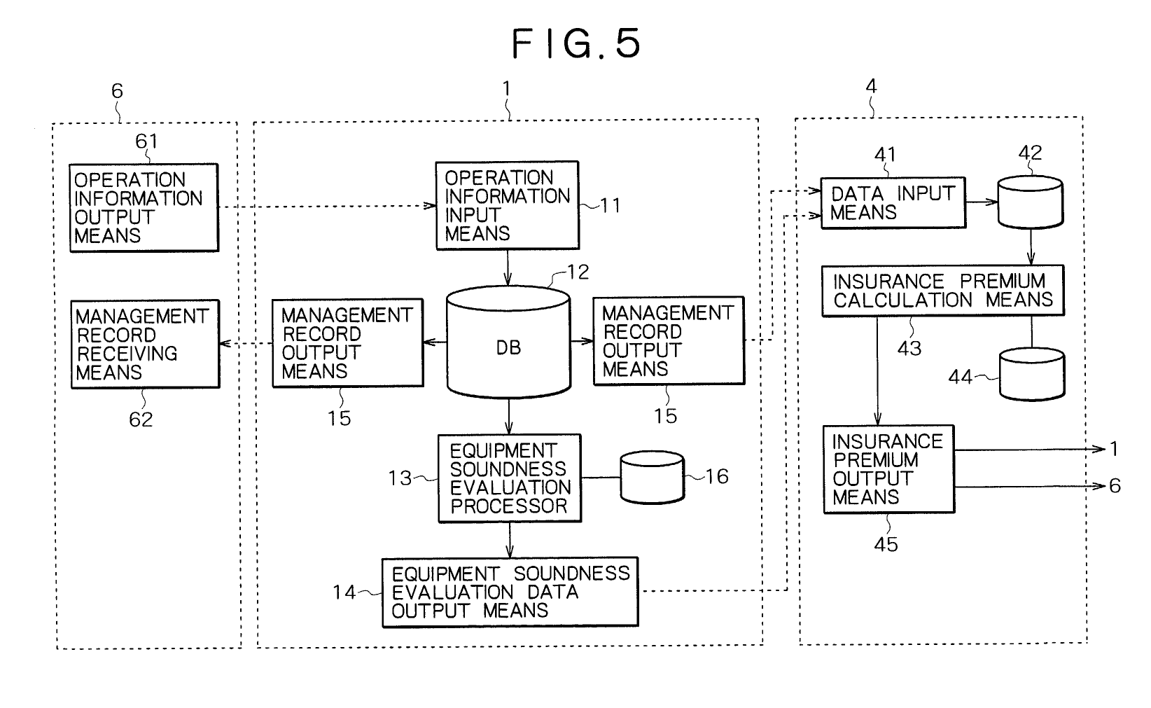

Further, FIG. 5 shows an example of a hardware configuration of the third embodiment. FIG. 5 illustrates power generating equipment 6, a service center 1 and a hardware configuration arranged at an insurance company 4. Here, the power generating equipment 6 and the service center 1 are connected to each other with communication means such as the Internet. In addition, the service center 1 and the insurance company 4 are connected to each other with communication means such as the Internet.

The power generating equipment 6 is primarily provided with an operation information output means 61 that outputs operation information to the service center 1 via the communication means, and a management record receiving means that obtains information on management records from the service center 1. Consequently, the power generating equipment 6 may easily obtain necessary management record information from the service center 1. In addition, the service center 1 may receive information on the soundness of power generating equipment.

The service center 1 is provided with an operation information input means 11 that receives operation information from the power generating equipment 6; a database 12 which memorizes and stores the operation information at required periods; a management record output means 15 which outputs management records for respective desired periods based on the database 12 to the power generating equipment 6 or to the insurance company 4; an equipment soundness evaluation processor 13 which calculates soundness evaluation information for respective desired periods based on the database 12; and an output means 14 which can output the equipment soundness evaluation information to the insurance company 4 at desired periods. Furthermore, a memory means 16 which store the equipment soundness evaluation information may also be incorporated.

Accordingly, in such manner, information required for the power generating equipment 6 or the insurance company 4 can be output, thus enabling an improvement in the management reliability of the equipment.

The insurance company 4 is primarily provided with an information input means 41 that obtains the equipment soundness evaluation information or information on management records from the service center 1 via communication means; a memory means 42 which store the information; an insurance calculation means 43 which calculate insurance premiums based on the information; a memory means 44 which store the insurance premiums; and an insurance premium output means 45 which output the insurance premiums to the service center 1 or the power generating equipment 6 via communication means.

Accordingly, in such manner, the insurance company can determine adequate insurance premiums.

According to the present invention, as stated above, the dodge of risks to be incurred by a generating plant firm which owns self-generation facilities, etc. can be clarified, and a generating plant firm may reduce the funds for starting up a business, which are required to initiate a power generating business, by utilizing a leasing service.

Although the invention has been described in its preferred embodiments with a certain degree of particularity, obviously many changes and variations are possible therein. It is therefore to be understood that the present invention may be practiced otherwise than as specifically described herein without departing from the scope and spirit thereof.

What is claimed is:

1. A method for surveillance and operation services of power generating equipment that supplies electric power to an electric power system, comprising the steps of:
taking an intermediary action to conclude a first indemnity insurance agreement between a generating plant firm which has power generating equipment and an insurance company for the soundness or the performance of said power generating equipment;
concluding a second indemnity insurance agreement between a managing operator of said electric power system and an insurance company for the supply of electric power; and
supplying a required amount of power when said electric power system is subjected to an unscheduled shutdown.

2. A method for surveillance and operation services of power generating equipment according to claim 1, wherein the first indemnity insurance agreement for the soundness or the performance of said electric power generating equipment is concluded in a lump for a plurality of pieces of said power generating equipment, and the supply of said required amount of power is conducted by regulating the output of power generating equipment other than the power generating equipment which is subjected to an unscheduled shutdown.

3. A method for surveillance and operation services of power generating equipment according to claim 1 or 2, wherein a long-term maintenance agreement is concluded between a service center and a generating plant firm which owns said power generating equipment.

4. A method for surveillance and operation services of power generating equipment according to claim 1, 2 or 3, wherein a surveillance service or an operation service of target power generating equipment under a long-term maintenance agreement is executed to always monitor the soundness of the target power generating equipment, while an adequate amount of information is also disclosed to said insurance company so that the insurance company may judge the soundness of said target power generating equipment.

5. A method for surveillance and operation services of power generating equipment according to any one of claims 1 to 4, wherein power generating equipment which is owned by said generating plant firm is used under a lease agreement.

6. A system for surveillance and operation services of power generating equipment that supplies electric power to an electric power system, comprising:
power generating equipment which is owned by one or a plurality of generating plant firms which supply electric power to said electric power system; and
a service center which carries out a surveillance service or an operation service of said power generating equipment to always to monitor the soundness of target power generating equipment, takes a first intermediary action to conclude an indemnity insurance agreement for the soundness or the performance of said power generating equipment between a generating plant firm which has the power generating equipment and an insurance company, and concludes a second indemnity insurance agreement for the supply of electric power between a managing operator of said electric power system and the insurance company so that a required amount of power may be supplied when said electric power system is subjected to an unscheduled shutdown.

7. A system for surveillance and operation services of power generating equipment that supplies electric power to an electric power system, comprising:
a database which stores operation information on said power generating equipment;
means for picking up such information that enables the judgment of the soundness of said power generating equipment from said operation information; and
means for offering such information that enables the judgment of the soundness of said power generating equipment to an insurance company.

8. A system for surveillance and operation services of power generating equipment that supplies electric power to an electric power system, comprising:
a database which stores operation information on said power generating equipment;
means for picking up such information that enables the judgment of the soundness of said power generating equipment from said operation information;
means for offering such information that enables the judgment of the soundness of said power generating equipment to an insurance company; and
means for, if said power generating equipment is subjected to an unscheduled shutdown, enabling information on the unscheduled shutdown to be transmitted to an insurance company.

9. A system for surveillance and operation services of power generating equipment that supplies electric power to an electric power system, comprising:
a database which stores operation information on said power generating equipment;
output means for enabling operation information for any desired period of time to be transmitted to said power generating equipment; and
output means for enabling the operation information for any desired period of time to be transmitted to an insurance company.

10. A system for surveillance and operation services of power generating equipment that supplies electric power to an electric power system, comprising:
a database which stores operation information on said power generating equipment;
output means for enabling operation information for any desired period of time to be transmitted to said power generating equipment;
output means for enabling the operation information for any desired period of time to be transmitted to an insurance company; and
means for, if said power generating equipment is subjected to an unscheduled shutdown, enabling information on the unscheduled shutdown to be transmitted to an insurance company.

11. A system for surveillance and operation services of power generating equipment that supplies electric power to an electric power system, comprising:
means for calculating an insurance premium when said power generating equipment is subjected to an unscheduled shutdown, based on operation information on said power generating equipment or information which enables the judgment of the soundness of said power generating equipment.

12. A method for surveillance and operation services of power generating equipment that supplies electric power to an electric power system, comprising the steps of:
obtaining information that enables the judgment of the soundness of the power generating equipment from operation information on said power generating equipment, which is stored in a database; and,
offering the information that enables the judgment of the soundness of said power generating equipment to an insurance company.

13. A method for surveillance and operation services of power generating equipment that supplies electric power to an electric power system, comprising the steps of:
transmitting operation information for any desired period of time from a database which stores the operation information on said power generating equipment to said power generating equipment via communication means; and
transmitting the operation information for any desired period of time to an insurance company.

14. A method for surveillance and operation services of power generating equipment that supplies electric power to an electric power system, wherein an insurance premium for a case where said power generating equipment is subjected to an unscheduled shutdown is calculated based on operation information on said power generating equipment or information which enables the judgment of the soundness of said power generating equipment.
